(19) United States
(12) Patent Application Publication
(10) Pub. No.: US 2022/0325459 A1
(43) Pub. Date: Oct. 13, 2022

(54) SYSTEMS AND METHODS FOR MANAGING HOME APPLIANCE WATER USE

(71) Applicant: The Procter & Gamble Company, Cincinnati, OH (US)

(72) Inventors: Anna L. Connolly, Newcastle (GB); Colin John Clarke, Hampshire (GB); Robert Webbink, Sharonville, OH (US); Nathalie Sophie Letzelter, Trimdon (GB)

(21) Appl. No.: 17/692,274

(22) Filed: Mar. 11, 2022

Related U.S. Application Data
(60) Provisional application No. 63/168,286, filed on Mar. 31, 2021.

(51) Int. Cl. D06F 33/46; D06F 39/00; D06F 39/10; D06F 39/08; C02F 1/00

(52) U.S. Cl. CPC D06F 33/46; D06F 39/006; D06F 39/10; D06F 39/083; C02F 1/001; C02F 2103/002

(57) ABSTRACT

A water use management system may be installed in a setting that contains a primary infrastructure for water use to provide an alternate, modular infrastructure for water use. Fresh water used at various points of use, such as a shower or sink, may be diverted into the modular infrastructure prior to draining into the primary infrastructure. Once diverted, the precedent use water is received at a reservoir system where it is treated for a subsequent use. Treatment may include filtration and/or chemical treatment, and may be based upon sensor feedback from the reservoir system. Once treated, the water is ready for subsequent use and may flow from the reservoir system, via the modular infrastructure, to a subsequent point of use, such as a toilet.

### FIELD

The present disclosure relates to systems and methods for managing domestic storage, treatment, and use of water.

### BACKGROUND

Water scarcity is becoming an increasing problem for many countries, with the scale of the impact affected by multiple factors such as population growth, climate change and the increasing demands of both industry and agriculture. Thus, the demand for water is likely to become further strained in the decades ahead, and indeed many global cities face supply vs demand shortages than cannot be met by today's strategies. One approach to ensuring residential homes have sufficient resources to meet these scarcity challenges is the principle of re-use, in that certain water streams within the home are re-used or re-purposed for a secondary use, sometimes characterized as “greywater.” Conventional approaches to such re-use focus on a “whole home” approach, and require significant initial costs (e.g., installation of hardware and infrastructure, reconfiguration of supply lines and drains, etc.) and maintenance costs (e.g., treatment, cleaning, especially around water waste classified as “sewage”).

The resulting system may treat and divert multiple residential streams of water back to a single stream potable, or non-potable quality form for secondary re-use application (e.g., substantially all water used in the home is diverted to a single reservoir which feeds all future use). However, this potable or non-potable form is not optimized for any particular use and does not take into account the specific needs of the secondary purpose, and so in some cases the treatment of input water may be inefficient, unnecessary, or unsuitable based on the water's previous use and actual characteristics. Due to the high cost of implementation and maintenance, as well as the static, rather than dynamic or reactive, treatment of water, the scale of the savings realized by residential homes using conventional graywater systems is limited, and so they are not considered to be a feasible or realistic option for the majority of domestic users.

### SUMMARY

In one form, a method comprises receiving, by a reservoir device, a volume of waste water from a washing machine, the washing machine having a waste water output and one more water inputs, wherein the reservoir device is in fluid communication with the waste water output and at least one of the one or more water inputs. The method further comprises storing, by the reservoir device, the volume of waste water in a reservoir of the reservoir device. The method further comprises converting, by the reservoir device, the volume of waste water into a volume of recycled water. The method further comprises identifying, by the reservoir device, a cycle type of a cycle being performed by the washing machine. The method further comprises storing, by a processor, a water use sequence that identifies a plurality of cycle types and, for each of the plurality of cycle types, whether that cycle type uses recycled water or fresh water. The method further comprises, based upon the cycle type and the water use sequence, providing, by the reservoir device, at least a portion of the volume of recycled water to the washing machine for the cycle; or providing, by the reservoir device, a volume of fresh water to the washing machine for the cycle.

In another form, a method comprises receiving, by a reservoir device, a volume of waste water from a first point of use, wherein the reservoir device point is in fluid communication with a waste water output of the first point of use and a water input of a second point of use. The method further comprises storing, by the reservoir device, the volume of waste water in a reservoir of the reservoir device. The method further comprises converting, by the reservoir device, the volume of waste water into a volume of recycled water. The method further comprises identifying, by the reservoir device, a water use event of the second point of use. The method further comprises determining, by a processor, whether to provide recycled water or fresh water to the second point of use based on the water use event. The method further comprises, based on the determination, providing, by the reservoir device, at least a portion of the volume of recycled water to the second point of use for the water use event; or providing, by the reservoir device, a volume of fresh water to the second point of use for the water use event.

In another form, a device comprises a set of connections configured to couple to a waste water output and one or more water inputs of a washing machine. The device further comprises a reservoir configured to receive and store a volume of waste water from the washing machine. The device further comprises one or more treatment devices configured to convert the volume of waste water into a volume of recycled water. The device further comprises a processor configured to identify a cycle type of a cycle being performed by the washing machine. The processor is further configured to store a water use sequence that identifies a plurality of cycle types and, for each of the plurality of cycle types, whether that cycle type uses recycled water or fresh water. The processor is further configured to, based upon the cycle type and the water use sequence, provide at least a portion of the volume of recycled water to the washing machine for the cycle; or provide a volume of fresh water to the washing machine for the cycle.

In another form, a device comprises a set of connections configured to couple to a waste water output of a first point of use and a water input of a second point of use. The device further comprises a reservoir configured to receive and store a volume of waste water from the first point of use. The device further comprises one or more treatment devices configured to convert the volume of waste water into a volume of recycled water. The device further comprises a processor configured to identify a water use event of the second point of use. The processor is further configured to determine whether to provide recycled water or fresh water to the second point of use based on the water use event. The processor is further configured to, based on the determination provide at least a portion of the volume of recycled water to the second point of use for the water use event; or provide a volume of fresh water to the second point of use for the water use event.

### BRIEF DESCRIPTION OF THE DRAWINGS

The above-mentioned and other features and advantages of the present disclosure, and the manner of attaining them, will become more apparent and the disclosure itself will be better understood by reference to the following description of non-limiting embodiments of the disclosure taken in conjunction with the accompanying drawings, wherein:

FIG. 1 is a schematic diagram illustrating exemplary water uses.

FIG. 2 is a schematic diagram illustrating an exemplary system for managing water use.

FIG. 3 is schematic diagram of an exemplary point of use reservoir.

FIG. 4 is a front perspective view of an exemplary point of use reservoir.

FIG. 5 is a front elevation view of the point of use reservoir of FIG. 4.

FIG. 6 is a rear elevation view of the point of use reservoir of FIG. 4.

FIG. 7 is a schematic diagram illustrating the flow of water through the point of use reservoir of FIG. 4.

FIG. 8 is a schematic diagram illustrating a set of cycle sensors usable with a point of use reservoir device.

FIG. 9 a flowchart of an exemplary set of high level steps that may be performed with a point of use reservoir device to capture and reuse water.

FIG. 10 is a flowchart of an exemplary set of steps that may be performed with a point of use reservoir device to configure cycle characteristics of a washing machine.

FIG. 11 is a flowchart of an exemplary set of steps that may be performed with a point of use reservoir device to selectively capture and treat water.

FIG. 12 is a flowchart of an exemplary set of steps that may be performed with a point of use reservoir device to identify a current cycle of a washing machine.

FIG. 13 is a flowchart of an exemplary set of steps that may be performed with a point of use reservoir device to selectively provide recycled water to a point of use.

FIG. 14A is a schematic diagram showing an exemplary water use sequence for a washing cycle.

FIG. 14B is a schematic diagram showing another exemplary water use sequence for a washing cycle.

FIG. 14C is a schematic diagram showing yet another exemplary water use sequence for a washing cycle.

### DETAILED DESCRIPTION

The present disclosure relates to systems and methods for managing the storage, treatment, and use of water in domestic environments. Various nonlimiting embodiments of the present disclosure will now be described to provide an overall understanding of the principles of the function, design and operation of the systems and methods. One or more examples of these nonlimiting embodiments are illustrated in the accompanying drawings. Those of ordinary skill in the art will understand that the systems and methods described herein and illustrated in the accompanying drawings are nonlimiting example embodiments and that the scope of the various nonlimiting embodiments of the present disclosure are defined solely by the claims. The features illustrated or described in connection with one nonlimiting embodiment may be combined with the features of other nonlimiting embodiments. Such modifications and variations are intended to be included within the scope of the present disclosure.

Due to the cost, complexity, and maintenance requirements of “whole home” water treatment systems, it may be advantageous to utilize small scale methods and devices to provide water use and reuse management at a particular point of use, that is particularized for that point of use, rather than trying to broadly capture and reuse water across an entire residence. As an example, this might include external and/or peripheral systems and devices that capture water from a specific point of use, such as a washing machine, and make limited reuse of that water for the same washing machine, or for another point of use that is proximately located to the washing machine. In this manner, the limited scope of the water management may be an advantage rather than a burden, as compared to whole-home systems. These limited scope water use and re-use management systems may be combined with point of use water treatment devices, or water conditioners, such as the systems disclosed in U.S. Provisional Patent Application No. 63/118,176, filed on Nov. 25, 2020, the entire disclosure of which is incorporated by reference herein.

An example of a point of use that may benefit from a specialized water management system is the washing machine. Water waste from a washing machine may be a poor candidate for capture and re-use by whole home systems due to the contaminant content, including washing detergents and clothing fibers, and the washing machine may also be a poor candidate for receiving greywater from a whole home system due to the impact that such water can have on the performance of laundry detergents, and the overall process of cleaning clothing. For example, many whole home systems may provide hard water, which can hinder detergent performance and cause build-up over time that gives clothing a ‘dingy’ appearance. As another example, many whole home systems leave small amounts of soil in secondary use water, or subsequent use water, even after treatment and filtration, which can build up in clothing over time and again cause an undesirable appearance or feeling, especially in whites and light colored clothing.

Another difficulty with using greywater with washing machines is effectively pairing water management techniques with the operation of a particular washing machine, and the characteristics of particular cycles of washing machines. As described above, not all greywater, unless filtered and treated to high standards, is appropriate for use with a washing machine, and even high quality greywater may be inappropriate for certain portions of laundry cycles. Implementations of the disclosed system and method may provide water savings of up to 60% or more, based upon particular user habits (e.g., the system may encourage users to opt for washing machine modes or cycles that maximize use of recycled water).

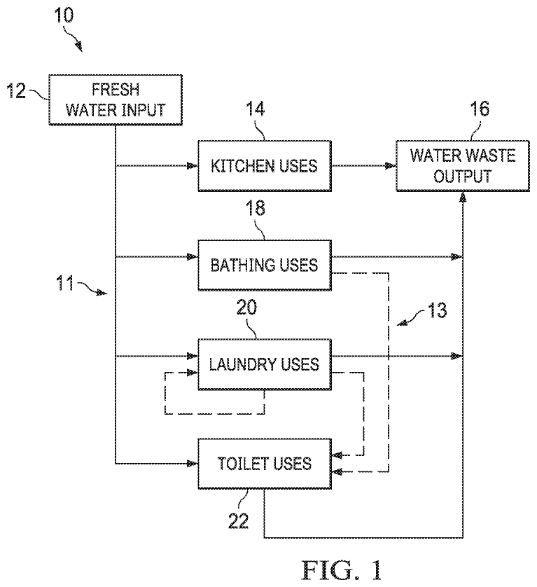

Turning now to the figures, FIG. 1 shows a schematic diagram illustrating exemplary water uses within a domestic setting 10, such as a household. Primary infrastructure 11 related to water use (e.g., copper or plastic pipes providing fresh water, plastic drain pipes that divert used water to a sewage system) is illustrated as solid lines, while modular infrastructure 13, which may include point of use water treatment devices as described herein, are illustrated as dashed lines. Fresh water enters the domestic setting 10 via the primary infrastructure 11 from a fresh water input 12, which may be, for example, a water treatment plant or other public utility, a public water storage reservoir, a fresh water well, or another water table access point. Water provided by the fresh water input 12 is used in a variety of ways within the domestic setting, such as kitchen uses 14 (e.g., sink, dishwasher), bathing uses 18 (e.g., shower, sink), laundry uses 20 (e.g., washing machine), and toilet uses 22. In addition to providing water for various uses, the primary infrastructure 11 also provides drainage from those uses to a water waste output 16, such as a public sewage system, cesspool, or septic system.

As can be seen, the modular infrastructure 13 is more limited in the scope than the primary infrastructure 11. The modular infrastructure 13 may be encased within the structure of the domestic setting 10 (e.g., encased within walls, floors, or ceilings), or may be installed externally to such structures. The modular infrastructure 13 may include some aspects of the primary infrastructure 11, such as copper or plastic piping encased within structures, but may also include flexible tubing, flat tubing, temporary tubing with quick attach and release features, and other materials to aid in transport of water across relatively short distances and/or within a single room or adjacent rooms. In some implementations, the modular infrastructure 13 may also include transportable mobile elements, such as canisters, cartridges, or tanks that may be carried or otherwise conveyed (e.g., such as by rolling on a set of wheels) from location to location. In some implementations, the modular infrastructure 13 may include point of use water treatment devices that may receive fresh water, or treated water, and perform treatments on demand at a point of use, as will be described in more detail below.

While the particular layout and design of the modular infrastructure 13 will depend upon particular households and varying implementations, and may also change from to time as modular connections are added or removed, FIG. 1 shows several exemplary connections that are generally effective. For example, water that is used for bathing uses 18, generally in a bathroom, may be captured by the modular infrastructure 13, treated and stored, as will be described in more detail below, and then redirected for toilet uses 22 rather than flowing to the water waste output 16. Similarly, water that is used for laundry uses 20 may be captured by the modular infrastructure 13 and then re-used one or more times for laundry uses 20, after treatment and storage, and then redirected for toilet uses 22. Water used for toilet uses 22 is generally too difficult to treat in a manner that is both efficient and acceptable for wide use, and so may be diverted directly to water waste output 16. In other implementations, the modular infrastructure 13 may provide captured water for other subsequent uses, such as for watering plants or lawns, and may capture water from additional sources, such as dishwashers, kitchen sinks, or rain water from a roof or gutters. A significant advantage of the modular infrastructure 13 is its minimal footprint and application, as compared to conventional whole home water re-use systems. Significant gains in efficiency, ease of use, and cost of maintenance are possible by implementing the modular infrastructure 13 in a limited way, and utilizing it based upon various dynamic factors such as sensor data, usage history, user requests, and other inputs as will be described in more detail below.

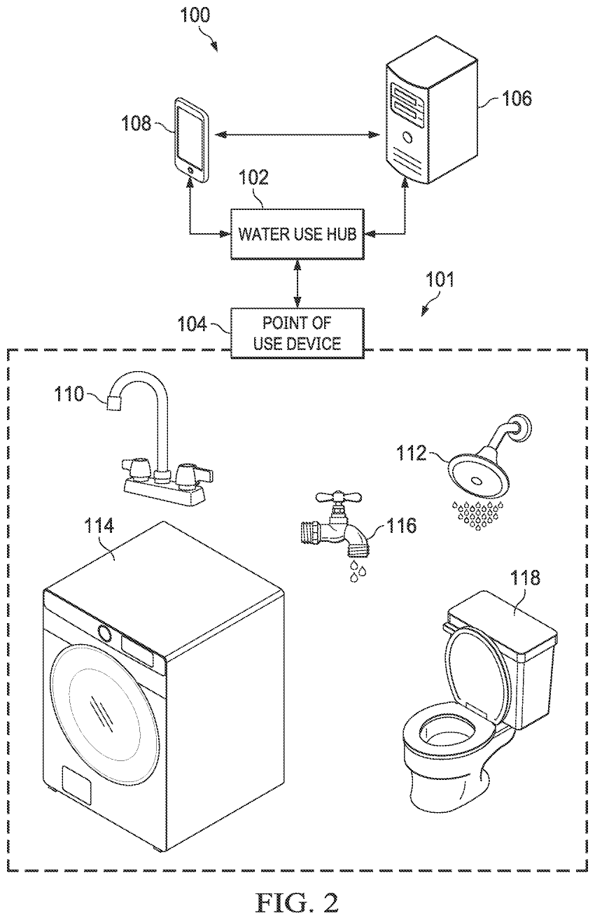

FIG. 2 is a schematic diagram illustrating an exemplary system 100 for managing water use. The system 100 may be implemented to enable some or all of the aspects of FIG. 1, such as using the modular infrastructure 13 to allow water management outside of the primary infrastructure 11. Points of use 101 illustrated in FIG. 2 include a sink 110 (e.g., within a bathroom, and intended primarily for handwashing and dental hygiene), a shower 112, and a toilet 118, which are typically grouped into the same room or at least proximately located to each other within the setting, as well as a washing machine 114, and an outdoor faucet 116, typically located in other rooms and at varying distances from each other and from other points of use. One or more point of use devices 104 may be installed and configured for one or more of the points of use 101 to enable such features as water modification at the point of use, real time or on demand water modification, water capture, treatment and re-use, and other beneficial features.

While not required in all implementations, the exemplary system 100 depicted in FIG. 2 also includes a water use hub 102, which is in communication with one or more devices such as point of use devices 104, and which itself is in communication with one or more remote servers 106 and one or more user devices 108. The water use hub 102 may be a computer, a router, hub, switch, or other network device, or a proprietary device having adequate processing, storage, and communication capabilities to allow wired and/or wireless transmission and receipt of data, as well as processing, storage, and analysis of data. In some implementations, the water use hub 102 may be a smartphone or other personal computing device in the possession of a person within the setting, and so may also be a user device 108. Wired data connections may be by USB, Ethernet, broadband over power lines, or other wired connections. Wireless data connections may be Wi-Fi, Bluetooth, IR, NFC, or other short, medium, or long range wireless transmission. The remote server 106 may be one or more physical, virtual, cloud, or other server environments configured to transmit and receive data over a wide area network (e.g., the internet), and to store, modify, and analyze data. The user devices 108 may include one or more smartphones, tablets, computers, laptops, wearable devices, gaming device, proprietary devices, or other personal computing devices such as might be in the possession of a person inhabiting or visiting the location at which the system 100 is implemented.

Referring to FIGS. 1-2, data exchanged between the water use hub 102 point of use devices 104 may include, for example, usage data indicating volumes and occurrences of water entering and exiting the network, water entering the system from the fresh water input 12, water exiting the system via the water waste output 16, the status of point of use devices 104, which may include battery charge level, filter status, cartridge status and fill level, and other information. As an example, the point of use devices 104 may from time to time communicate via a wireless LAN and report general status information to the water use hub (e.g., currently in use, volume of water dispensed over period of time, battery level, cartridge fill level, cartridge contents, or other information, water temperature) as well as targeted notifications (e.g., change battery warning, change or replace cartridge warning, detection of leaky faucet, dangerous water temperature warning, or other warnings).

Data available to the water use hub 102 might also include user data that is gathered based upon historic uses or is received from a user device 108, or both. This may include, by manual configurations received via a user device 108 and/or predictive information derived from past usage, a number of persons using water within the setting, the days and times that each person is likely to take a shower, wash clothing, use an outdoor faucet, or perform some other water use, or dynamically requested particular uses (e.g., such as an indication from a user device 108 that a user is preparing to wash a car or water plans).

Data available to the water use hub 102 might also include sensor data describing characteristics of water used at points of use 101. This may include data from sensors capable of determining various characteristics of volumes of water. Such information might be used by point of use devices 104 or other devices to evaluate and prepare captured water for subsequent uses, and may be reported to the water use hub 102 so that it may be used for other purposes such as identifying ways to improve the overall quality of water in a household, to detect the presence of contaminants, or to suggest different products (e.g., chemical treatment cartridges, filtration modules) that may improve or reduce the level of chemical contaminants present in water at the point of use 101.

Data gathered by the water use hub 102 may be provided to a remote server 106 and used as part of aggregate information on water use across a group of users or a geographical area from which it originated, for example, and may be used to produce and refine configurations of the a plurality of systems 100 across many users. For example, data reported from a plurality of users within a single city may indicate that most or all residents of the city receive water with an undesirably high mineral content from the fresh water input 12. Such information may be used to remotely configure many point of use devices 104 within that city, to account for and treat the known high mineral content. The water use hub 102 and/or server 106 may also use gathered data to communicate with the user device 108 and provide information, recommendations, and other data to users via a one or more graphical user interfaces. For example, the user device 108 may receive a notification indicating high mineral content in the fresh water input 12, and recommending a whole-home water softener or other solution. As another example, the user device 108 may receive a notification indicating that, based on their historic and/or configured usage sequences, if they can wash a load of laundry at 9 p.m. instead of at 7 p.m., the entire water usage for that wash will come from re-used water that will be available at that time, instead of from the fresh water input 12. As another example, the user device 108 may receive a notification indicating that a chemical cartridge fill level for a point of use device 104 is low and should be replaced.

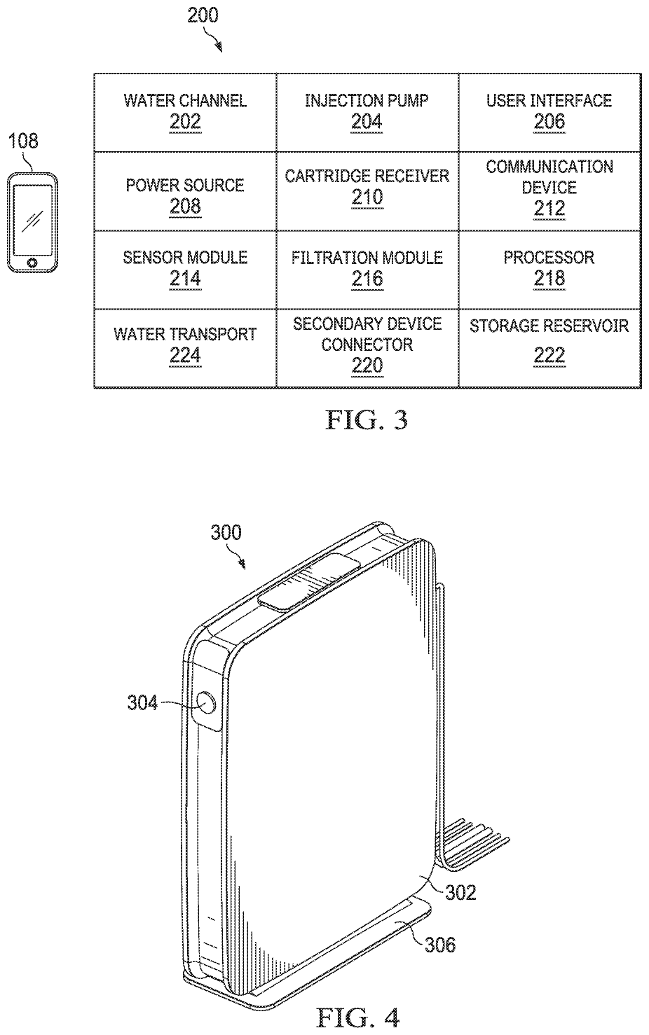

As further example of a point of use device 104, FIG. 3 shows a schematic diagram of a point of use reservoir 200, which may also be referred to as a residential water conditioner, that is operable to capture and/or modify water at a point of use such as a shower or washing machine. Water modifications may include, for example, filtering, injection of chemical treatments (e.g., to modify pH), and injection of user experience treatments (e.g., to provide scented water, colored water, or carbonated water). The point of use reservoir 200 includes a water channel 202 that receives water as input from the fresh water input 12, or as previously used and captured water and transports the water to a storage reservoir 222, or an output at the point of use (e.g., a shower head, washing machine). Filtering, treatment, and other modifications to the water may be performed on water while it is traversing the water channel 202, while it is stored in the storage reservoir (222), or both. In varying implementations, the water channel 202 may include one or more inputs (e.g., one input for fresh water 12, and one for water input from modular infrastructure 13, such as water captured for reuse), and one or more outputs (e.g., an output for a point of use such as a washing machine 114, an output for draining stored water, etc.).

The point of use reservoir 200 may include a treatment module in the form of one or more injection pumps 204 that are operable to introduce an additive to water flow in the water channel 202, or water stored in a storage reservoir 222. In varying implementations, injection pumps 204 may draw additives from an internal reservoir, or may draw additives from a cartridge or other external replaceable reservoir. In cartridge based implementations, the point of use reservoir 200 may include a cartridge receiver 210 that receives a cartridge containing chemical treatments, user experience treatments, or other additives, and provides such additives to the injection pumps 204. Cartridge receivers 210 may include additional features, such as optical, electrical, or wireless data readers or receivers operable to receive information from an inserted cartridge that is usable to identify the cartridge and its contents, or enable/disable other features of the point of use reservoir 200 based upon an inserted cartridge. Treatments provided to water may include the provision of one or more of surfactants, optical agents, dyes, fluorescent markers, buffers, pH modifiers, perfumes, de-scaling agents, metal sequestration agents, polymers, colors, surface tension modifiers, viscosity modifiers, lubrication agents, silicones, deodorization agents, bleaches including halogens and peroxygen compounds, preservation agents, biocidal agents, anti-fungal agents, anti-viral agents and cleaning compositions containing one or more of the preceding list.

The point of use reservoir 200 may include a user interface 206 that allows a user to provide inputs to the point of use reservoir 200, receive information from the point of use reservoir 200, or both. The user interface may include, for example, a display screen, a touch screen, a set of light indicators or other visual indicators, a set of buttons or other controls, voice activation features, or a software interface accessible wirelessly from another device (e.g., such as a smartphone connecting to the point of use reservoir 200 via Bluetooth or Wi-Fi). The user interface 206 may be configured to allow a user to activate certain water treatments, activate or deactivate water capture and reuse features, create and change software configurations of the point of use reservoir 200, receive information relating to the function of the point of use reservoir 200 such as operational status, cartridge contents, cartridge levels, and receive warning messages or other notifications relating to the function of the point of use reservoir 200.

The point of use reservoir 200 may include other features and components such as power sources 208 (e.g., a rechargeable/replaceable battery, hardwired connection, power cable), communication devices 212 (e.g., Bluetooth transceivers, Wi-Fi transceivers, optical transceivers, or other devices capable of receiving and transmitting data wirelessly or via a hardwired connection), processors 218 (e.g., one or more computer processors within the point of use reservoir 200 or within a device in communication with the point of use reservoir 200, that are configured to execute programming instructions and exchange control signals with other devices of the point of use reservoir 200 such as the injection pumps 204, user interfaces 206, and others), as well as components such as memories, storage devices, and sealants against water and humidity, for example. One or more processors 218 may also include computer processors of varying types include microprocessors, and may also include control boards, programmable logic devices, field programmable gate arrays, and other devices capable of receiving an input signal, determining an output signal, and providing the output signal to one or more other devices or components.

The point of use reservoir 200 may include a sensor module 214 that includes one or more sensor capabilities such as flow sensors, pressure sensors, contaminant sensors, water characteristic sensors (e.g., for determining pH, hardness, clarity), temperature sensors, motion sensors, proximity sensors, sound sensors, or other sensor devices capable of measuring physical characteristics of the proximate environment and generating datasets for use by the processor 218. Additional characteristics that may be measured by use of the sensor module 214 may include one or more of pH, conductivity, dissolved oxygen, chemical oxygen demand, biological oxygen demand, suspended solids, dissolved solids, turbidity, presence of pathogens, pathogenic levels, pathogenic species, fecal coliforms, presence of blood, human biomarkers, ammonia, residual chlorine, bromine, phosphorus, nitrogen, boron, turbidity, color, particle size, flow and temperature.

The point of use reservoir 200 may also include a filtration module 216, which may include one or more filtration membranes, chambers, or substances, and may be positioned inline along the water channel 202 (e.g., prior to the storage reservoir 222), prior to the water channel 202 and external to the point of use reservoir 200 itself (e g, inline along a hose or other channel that provides fresh water 12 to the point of use reservoir 200), or after the water channel 202 and external to the point of use reservoir 200 (e.g., inline along a hose or other channel that provides post-modification water to a point of use such as a shower 112). The filtration module 216 may filter water by one or more physical treatments such as gravitational separation, filtration, foam fractionation, hydro-dynamic separation, reverse osmosis, forward osmosis, ultra-filtration, nano-filtration, gravitational separation, sedimentation, centrifugation, flocculation, aeration, deaeration, and electro-coagulation.

In some implementations, the water channel 202 may have two or more outputs, with one output providing post-modification water to a point of use such as the shower 112, and a second output terminating at a secondary device connector 220. The secondary device connector 220 may be configured to couple with any of a variety of secondary devices to allow for post-modification water to be provided selectively to the shower 112, a connected secondary device, or both simultaneously. Secondary devices may receive a steady stream of water from the point of use reservoir 200 based upon the operation of a passive or active valve system within the water channel 202 and/or secondary device connector 220, or may include their own supply valve that controls the flow of water by pressing a button or adjusting another control, or both.

In some implementations, the point of use reservoir 200 may additionally be configured for point of use water capture and re-use via modular infrastructure. Such implementations may additionally include one or more storage reservoirs 222. The storage reservoir 222 may be inline with, or otherwise in fluid communication with the water channel 202, such that water received via some or all of the water inputs passes into the storage reservoir 222, and water from the storage reservoir 222 may flow out of the point of use reservoir 200 via one or more water outputs. Water provided by the point of use reservoir 200 may be from the fresh water input 12 that bypasses the storage reservoir 222 completely, may flow from the storage reservoir 222, or may be a mix.

Water that is provided to the storage reservoir 222 may be stored and treated or conditioned over time, while water bypassing the storage reservoir 222 may be treated and provided in real-time. Water provided to the storage reservoir 222 may be from the fresh water input 12, or may be water captured from a point of use via modular infrastructure 13. Water captured for treatment in the storage reservoir 222 during a precedent use may be treated, and then provided from the storage reservoir 222 for a subsequent use, and is typically captured prior to entering the primary infrastructure 11 (e.g., captured prior to entering a drain). Components of the point of use reservoir 200 related to water modification (e.g., the injection pump 204, the cartridge receiver 210, and the filtration module 216) may operate to treat water that bypasses the storage reservoir 222, water stored within the storage reservoir 222, or both. For example, where a point of use reservoir 200 may receive four cartridges including water modification chemistry, additive from each cartridge may be used to treat water in real-time or in the storage reservoir 222, or cartridges may be dedicated to particular uses (e.g., two cartridges may be used to treat water bypassing the storage reservoir 222, while two cartridges may be used to treat water within the storage reservoir 222).

Implementations of the point of use reservoir 200 having a storage reservoir 222 may also include a water transport device 224, which may be, for example, a pump that is operable to create pressure and/or vacuum in order to transport water within a closed system. The water transport device 224 may be operable to capture water from a point of use and transport it to the storage reservoir, and may be used to transport water from the storage reservoir 222 into the water channel 202 for output to a subsequent use.

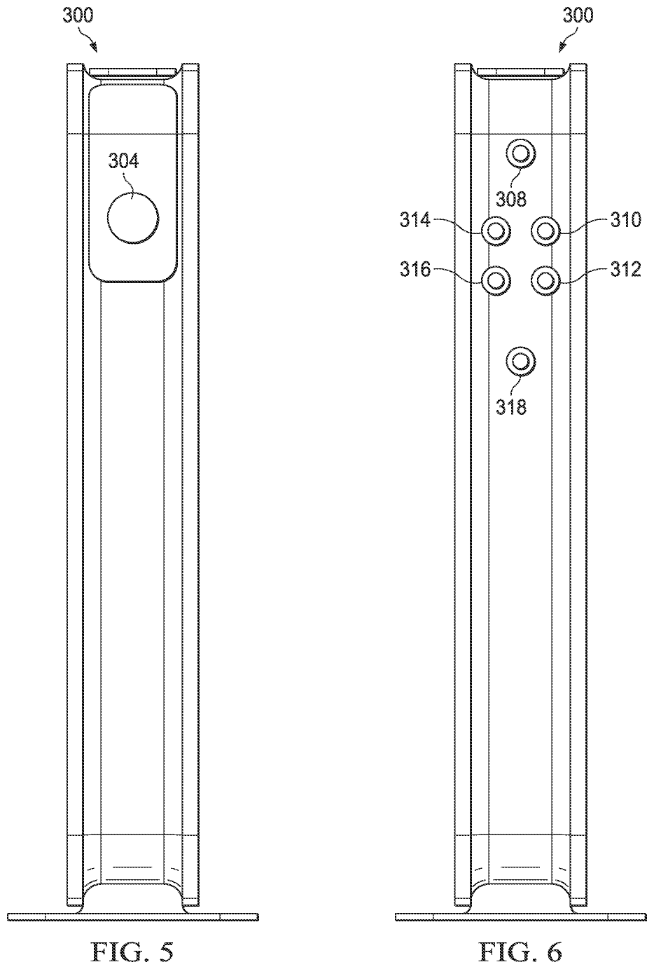

FIG. 4 is a front perspective view of an exemplary point of use reservoir, which may also be referred to as a reservoir device 300. The reservoir device 300 includes a case 302 with a stand 306, and a control interface 304 positioned on the front of the case 302. The case 302 and stand 306 may be varied in size and shape to provide a variety of different placement positions. As an example, in some implementations the case 302 may be adapted to mount flat against a wall or mount to a side of a washing machine, or may be shaped as a free standing cube or cylinder, or may be shaped as a rectangle that rests on top of, or sits below and supports, a washing machine, for example. FIG. 5 shows a front elevation view of the reservoir device 300, while FIG. 6 shows a rear elevation view of the reservoir device 300. The control interface 304 may be similar to the user interface 206, and may include a display with touchscreen capabilities or control buttons, and may be configured to display information such as the current operation of the reservoir device, a volume of stored water, the status of filter materials, the status of injectable treatment substances. The rear of the reservoir device 300 includes a number of connections for the input and output of water from the reservoir device 300. Each of the connections may be coupled to a supply hose or other line using a variety of connectors, such as screw on connectors and quick attachment or quick release couplings, and may also be appropriately labeled or otherwise visually marked to aid in connecting lines.

A waste water input 308 may be coupled to a waste water output line from a washing machine in order to receive water that drains from the washing machine. A cold water input 310 may be coupled to a fresh water input 12 that provides cold water. A cold water output 312 may be coupled to a cold water supply on a washing machine to provide cold water to the washing machine. A hot water input 314 may be coupled to a supply line that that provides fresh hot water (e.g., such as the fresh water input 12). A hot water output 316 may be coupled to a hot water supply on a washing machine to provide hot water to the washing machine. In some implementations, the hot water input 314 and hot water output 316 may be a simple pass-through channel, such that fresh hot water passes through the reservoir device 300 without being stored, treated, or filtered. Such implementations could supply recycled water for cold wash and rinse cycles, but would supply fresh water for hot wash and rinse cycles. Some implementations of the reservoir device 300 may include heating elements to heat water within a separate, hot water specific, storage reservoir, or heat water inline and on demand as it is supplied from a single reservoir. A drain output 318 may be coupled to a drainage pipe, so that water that is unsuitable for treatment and reuse, or that otherwise needs to be drained from the reservoir, may be transported to the water waste output 16.

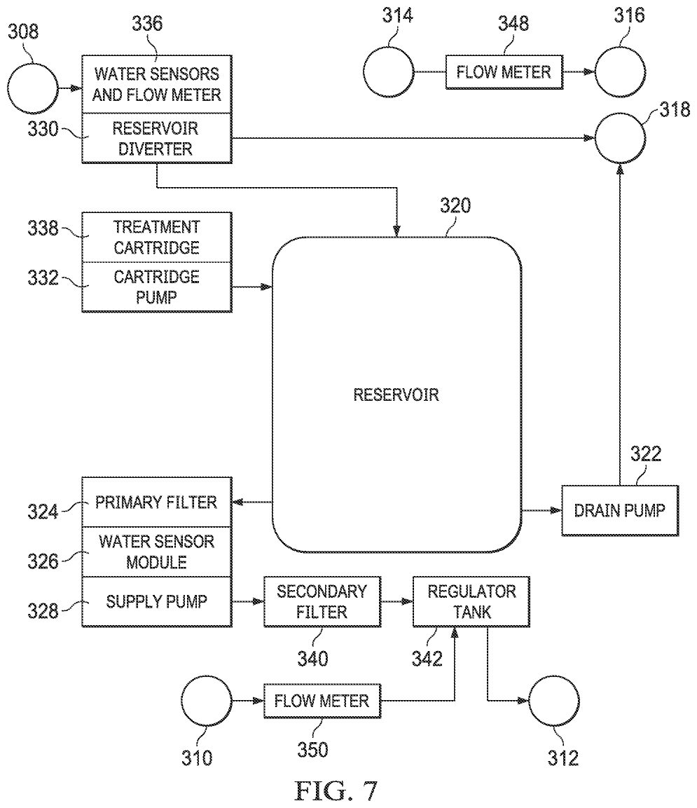

FIG. 7 shows a schematic diagram of the reservoir device 300 that schematically illustrates the path of each channel. The reservoir device 300 includes a processor, which may be one or more processors, logic controllers, or other controller devices, and which may be configured to provide control signals to operate the pumps, treatment devices, control interfaces 304, and other components of the reservoir device 300, and may have some or all of the features of the processor 218.

The case 302 of the reservoir device includes a reservoir 320 adapted to store water, which may have some or all of the features of the storage reservoir 222 of FIG. 3. Varying implementations may have two or more separate storage reservoirs 320 (e.g., cold water reservoir, hot water reservoir, pre-treated fresh water reservoir), and the capacity of storage reservoirs may vary between about 30 liters and about 100 liters, depending upon the type of washing machine or other water consuming appliance to which they are attached. The reservoir 320 may be in fluid communication with a drain pump 322 that is operable to transport water from the reservoir to the drain output 318, which may be necessary when water is determined to be unusable after capture, where it is stored within the reservoir 320 for a lengthy period of time, or where a user wishes to drain and move the reservoir device 300, for example.

A supply pump 328 is in fluid communication with the reservoir 320 and is operable to transport water from the reservoir for reuse by the washing machine or other appliance. The supply pump 328 may be a gear pump or other pump type capable of providing between about 4 liters and about 10 liters of displacement per minute at around 0.5 bar. Water transported by the supply pump 328 passes through a primary filter 324 and water sensor module 326. The primary filter 324 may be replaceable and/or serviceable and reusable. As one example, the primary filter 324 may be a two stage filter with a first stage having micron rating between about 30 and about 90, and may include features such as automated electrical or mechanical anti-clogging to clear the filter mesh (e.g., a mechanical brushing arm), and self-cleaning to divert filtered debris to the reservoir 320 or to a waste outlet. A second stage may have a micron rating between about 2 and about 10 microns, selected to filter fibers from water to wash clothing, and may be a removable and/or replaceable filter or serviceable component.

Filtered debris may be purged from the reservoir 320 and primary filter 324 using a low-mounted drain plug or outlet, or by use of an unfiltered drain pump such as the drain pump 322. The water sensor module 326 may sample water at rest within the reservoir 320, and water passing through the primary filter 324 by operation of the supply pump 328. The water sensor module 326 may determine the presence of contaminants in the water (e.g., bacteria, sediment, fibers), and such measurements may be used to determine whether stored water is reusable, or should be discarded via operation of the drain pump 322. The water sensor module 326, as well as the water sensors 336 may include some or all of the features described in the context of the sensor module 214 of FIG. 3.

A treatment cartridge 338 includes a receiver that may receive and couple with a cartridge of chemical treatment or other substance usable to treat captured water to prevent bacterial growth, neutralize detergents or other chemicals, reduce mineral content, and otherwise improve the quality of water for reuse. A cartridge pump 332 is operable to transport treatment substances from the treatment cartridge 338 directly into the reservoir 320, or into the stream of incoming waste water received from the washing machine via the waste water input 308. Treatment may also be provided by ultraviolet or ozone sanitization of water within the reservoir 320 or within a transport channel. An inbound water sensor module 336 may be similar to the water sensor 326, but is positioned near and in fluid communication with the waste water input 308. This water sensor module 336 is configured to determine characteristics of captured water prior to entering the reservoir 320, and may measure characteristics such as chemical contaminants from detergents or other laundry treatments, physical contamination from dirt or fibers, or biological contamination from bacteria or biological material. Information from this water sensor module 336 may be used determine the status of a diverter valve 330 of the waste water input 308. The diverter valve 330 may be actuated, based upon the configured state of the reservoir device (e.g., the device may be in a disabled mode where water is not stored or treated) or the output of the water sensor module 336, between a first state where incoming waste water flows into the reservoir 320, and a second state where incoming water flows to the drain output 318 and is discarded without passing through the reservoir 320.

Water transported by the supply pump 328 passes through a secondary filter 340, and, in some implementations, enters a regulator tank 342. The secondary filter 340 removes particulate and fibrous debris from recycled water prior to exiting the reservoir device 300 and being provided to the washing machine or other point of use. Each of the primary filter 324 and secondary filter 340 may include some or all of the features of the filtration module 216 of FIG. 3. The regulator tank 342 may include a water feed valve system that is operable to selectively receive recycled water from the reservoir 320, fresh cold water from the cold water input 310, or both, depending upon the availability of recycled water and the particular cycle of the washing machine. The valves of the regulator tank 342 may be configured to provide only recycled water, only fresh cold water, or a mix to achieve a certain outgoing pressure while preventing pressure spikes or other water flow that might negatively influence the operation of the washing machine. A hot water bypass is configured to receive hot water from the hot water input 314 and direct it to the hot water output 316 without entering the reservoir 320.

With reference to FIG. 7, the path that water takes through the system is clearly illustrated. Used water from the washing machine enters the reservoir device through the waste water input 308 where the sensor module 336 determines whether it is usable or not. Usable water flows to the reservoir device 320, while the reservoir diverter 330 directs unusable water to the drain output 318 where it is discarded. As has been described, water may be discarded in situations such as where the reservoir 320 is already at capacity, where the reservoir device 300 is in a disabled operation mode or powered off, where a manual user input flags a particular volume of water for disposal, or where the captured water has a chemical content, particulate content, or other content that is outside of configured boundaries indicating reusable water.

The hot water bypass is also illustrated as connecting the hot water input 314 to the hot water output 316. The cold water input 310 is illustrated as connecting to the regulator tank 342. A flow meter 348 is positioned inline on the hot water bypass, a flow meter 350 is positioned inline on the cold water input 310, and the water sensor module 336 may also include a flow meter. Each of the flow meters is configured to detect the flow of water into the system from a different source (e.g., waste water from washing machine, fresh cold water, fresh hot water), and such flow information may be used to control the operation of the reservoir device 300 and/or to provide information to users about their water use habits. As an example, information from the flow sensors may be used to provide an interface to a user via a user device 108 showing the total volume of fresh cold water and fresh hot water used during a period of time, and the total volume of water that was captured and reused by the system during the period of time. This may also include suggestions or recommendations based on such information, such as the amount of water that may be saved during a month or year if a user switches to only using cold wash cycles. As another example, flow data from the water sensor module 336 may be used to prepare other components to receive and measure, treat, or otherwise process incoming wastewater.

In FIG. 7, the treatment cartridge 338 and cartridge pump 332 are illustrated as treating water within the reservoir 320 directly. This may include regular injection of sanitizers into the reservoir 320 based upon the passage of time, the volume of stored water, measured characteristics of stored water, and other characteristics. As an example, this may include the introduction of a certain amount of sanitizer per-liter of stored water to prevent the growth of bacteria or mildew, as well as other examples as will be described in more detail below.

The drain pump 322 is shown receiving water from the reservoir 320, and diverting such water to the drain outlet 318 so that it can be discarded. The supply pump 328 is shown receiving water from the reservoir 320, which passes by or through the primary filter 324 and water sensor module 326, passes through the secondary filter 340, and enters the regulator tank 342. The regulator tank 342 is shown receiving water from the reservoir 320 and the fresh water input 310, and may include a set of valves that are selectively operable to supply only recycled water, only fresh water, or a mix of water to the cold water output 312.

In some implementations, a point of use reservoir such as the reservoir device 300 may selectively provide recycled water or fresh water to a washing machine or other point of use. As an example related to a washing machine, a single use of the washing machine may last for 90 minutes or more, and may include several discrete instances where water is supplied to the washing machine. As an example, this may include a wash cycle and one or more rinse cycles. In a typical scenario, the washing machine would receive fresh water, mix detergent with the fresh water, and perform an initial wash of the clothing. Once complete, the wash water would be disposed of, and fresh water would be again provided for a first rinse. Once the first rinse is complete, the rinse water would be disposed of, and fresh water would be again provided for a second, and sometimes final, rinse.

While a device such as the reservoir device 300 may be configured to capture and reuse the same volume of water each time the washing machine signals that water is needed, regardless of cycle (e.g., wash, first rinse, second rinse), it may be advantageous to identify each cycle as it occurs and selectively provide recycled water or fresh water based upon the identified cycle. As one example, this may include identifying the final rinse cycle of a washing machine, and providing fresh water for the final rinse, rather than recycled water. While this method of cycle detection and selective water use may be entirely pre-configured (e.g., the reservoir device 300 would have access to preconfigured cycle information for each mode of each washing machine, and would be able to determine the occurrence of cycles based upon elapsed time, or detection of outgoing waste water, or ingoing fresh water recycled water), it may also be advantageous to provide cycle detection devices usable with the reservoir device to aid in automatically learning washing machine cycles, or otherwise identifying washing machine cycles, where preconfigured cycle information is not available.

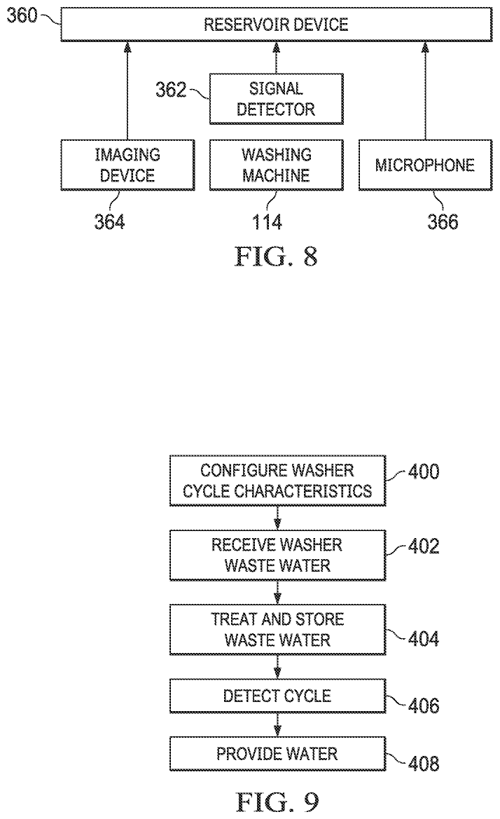

As an example, FIG. 8 is a schematic diagram illustrating a set of cycle sensors usable with a point of use reservoir device. A reservoir device 360, which may have some or all of the features of the reservoir device 300, or the point of use reservoir 200, may be in communication with one or more cycle detection devices, which may include an imaging device 364, a signal detector 362, or a microphone 366, for example. Cycle detection devices may couple directly with the washing machine 114 (e.g., via a diagnostic data connection, Bluetooth, Wi-Fi, or other communication channel) in order to receive data usable to identify a cycle, but may also be capable of determining a cycle without direct communication.

As one example, an imaging device 364 may include a camera or other optical receiver that may be positioned within view of the washing machine 114 interface screen and controls, and may be configured to determine the current mode and/or cycle of the washing machine 114 based upon displayed information, lighted signal indicators, or the positions of dials or buttons. Initial configuration of the imaging device 364 may include a user setting the washing machine 114 to each state (e.g., wash mode and cycle) and providing inputs that identify the characteristics of each state. Images of the washing machine 114 control interface (e.g., dials, buttons, light indicators, LED displays) may be captured in each state, and when future images matching those configured images are detected the reservoir device 360 can identify the state of the washing machine 114.

As another example, a microphone 366 or vibration sensor may be positioned near the washing machine 114 and configured to record audio during various operational states of the washing machine 114, or detect patterns of motion of vibration. As with the prior example, a user may initially set the washing machine 114 into each state and provide inputs identifying the characteristics of that state, and the recorded audio or vibration patterns associated with each state may be used to recognize that state in the future based upon subsequently recorded audio or vibration patterns.

As yet another example, a signal detector 362 may be coupled to or positioned nearby electrical components of the washing machine 114, such as the power cable, motor, control board, or user interface. The signal detector 362 may be configured to detect signals such as electrical current drawn by the washing machine 114, or passive electromagnetic signals or frequencies produced by the motor, control board, user interface, or other electrical components of the washing machine 114 during operation. As with prior examples, a user may initially set the washing machine 114 into each state and provide inputs identifying the characteristics of that state, and saved signal characteristics may be used to recognize that state in the future based upon subsequently detected signals.

The reservoir device 360 may also be capable of automatically identifying cycle characteristics and wash modes for a washing machine based upon information generated by the flow meters 348, 350 and other water sensors, and may utilize such automatic identifications independently, or in combination with information from a cycle sensor. As an example, once the reservoir device 360 is coupled to a washing machine, the reservoir device 360 may be placed into a training mode and each mode of the washing machine may be used. During each mode, the reservoir device 360 may determine characteristics such as the length of the wash mode (e.g., based upon audio feedback from the washing machine indicating it is running, or based upon a duration of elapsed time from a final draining of the washing machine with no subsequent draw of water), the start time, stop time, and duration of each cycle (e.g., based upon flow meter data showing when water was provided to the washing machine, and when water was drained from the washing), the volume and type of water provided, and other characteristics. Such information may be used to produce a timeline for when each cycle starts and stops, and the type of cycle (e.g., hot, warm, or cold, and whether the cycle was a rinse or wash based upon the volume of water drawn, whether detergent is present in the waste water, and the length of the cycle).

The disclosed reservoir devices may be fully or partially automated once installed and configured, such that user requirements are minimized to cleaning of filters, exchanging treatment cartridges, or other maintenance tasks. Features such as automatic cycle detection and sensor based diversion of water to either the reservoir 320 or drain outlet 318 allow a reservoir device to function with little manual configuration or input from a user, and do not require user inputs during each use, or between each cycle.

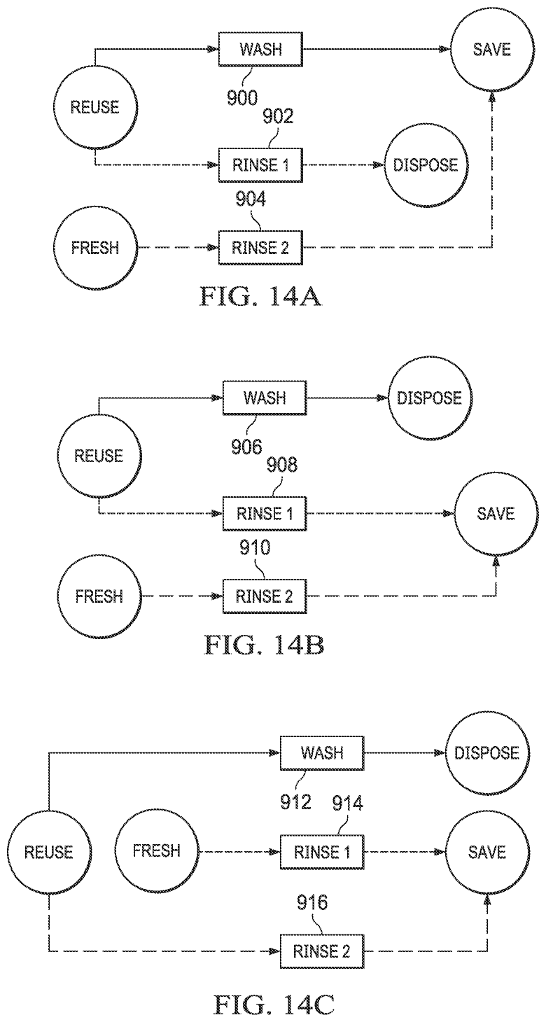

As an example, FIG. 9 shows a set of high level steps that may be performed with a point of use reservoir device, such as the reservoir device 300, to capture and reuse water. The washing machine cycle characteristics may be configured 400, which may include using cycle detection devices and techniques to capture information describing each cycle and wash mode, and configuring a corresponding water use timeline or sequence for each mode (e.g., FIGS. 14A-14C each show water use sequences, as will be described in more detail below). As waste water is received 402 from a washing machine, it may be treated 404 and stored in a reservoir tank of the reservoir device. Subsequently, as the washing machine is used, a current cycle may be detected 406 and identified, and the reservoir device may provide 408 water as it is needed, which may include providing reused and recycled water from the reservoir tank, fresh water, or a mix.

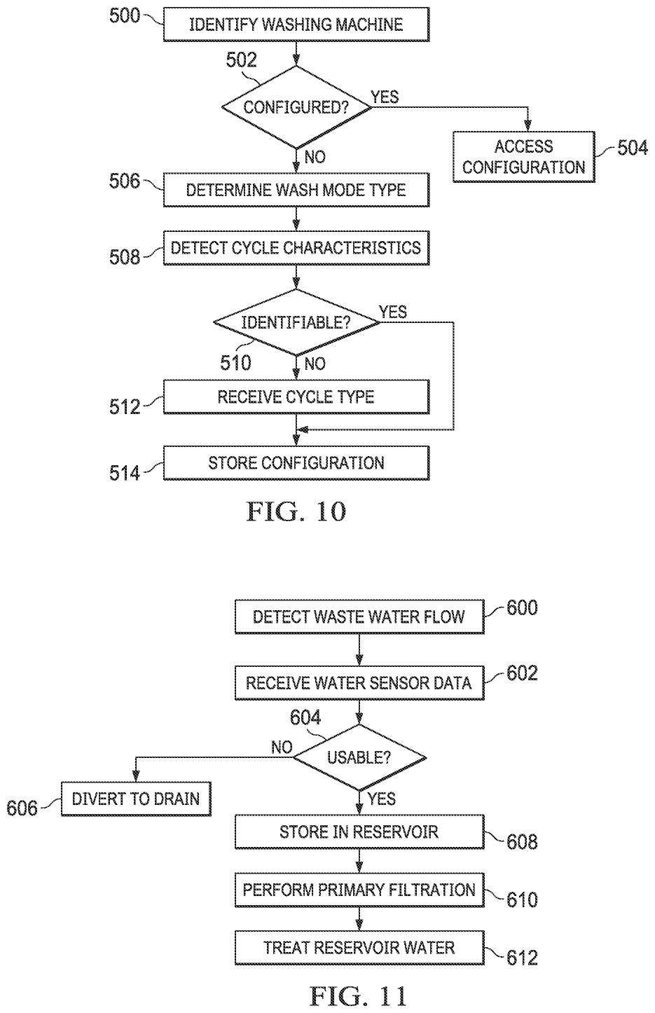

FIG. 10 is a flowchart of a set of steps that may be performed with a point of use reservoir device, such as the reservoir device 300, to configure cycle characteristics of a washing machine. When installed with a washing machine, the device may identify 500 the washing machine by receiving input from a user identifying the washing machine type and model. Such input may be provided by a user device 108 for example, and may be provided during a guided software setup to configure the reservoir device for use. The system may search for existing configurations 502 for the identified washing machine, and where present, may access 504 and use those configurations to determine the cycle characteristics of the washing machine. Existing configurations may be stored on remote servers 108 accessible by the user device 108 and/or reservoir device, and may be manually configured and made available by administrators of the system, residential users of the system, or manufacturers of washing machines, for example. As an example, where a user configures a reservoir device for cycle detection and use with a particular washing machine, such configuration may be provided to a remote server 106 and made available to other users of the system.

Where no configuration exists 502, the system may determine 506 the type of wash mode that the washing machine is currently operating in (e.g., normal wash, colors wash, quick wash, etc.) and then detect 508 the characteristics of each cycle. Determining 506 the wash mode type may include receiving manual input from a user identifying the mode, or may include automatically identifying the wash mode based upon feedback from a device such as the imaging device 364, signal detector 362, or microphone 366, or water and flow sensors of the reservoir device 300, which may also be used to detect 508 the cycle characteristics. If the type of cycle is identifiable 510 based upon the detected 508 cycle characteristics, the system may store 514 the cycle identity and associated characteristics so that it is more readily identifiable 510 in the future. The cycle may be identifiable 510 based upon a captured image of the control interface, captured audio of the cycle, detected electric or other signals, or water flow data matching or being substantially similar to prior characteristics that have been associated with certain cycles, as has been described.

Where the cycle is not automatically identifiable 510, the user may provide input that is received 512 and used to identify the cycle. As an example, during the first time that a certain cycle is performed the system may not be able to identify 510 the cycle due to a lack of historical comparison. In such an example, the user may identify the cycle as a wash, first rinse, second rinse, or so on, and such a received 512 cycle type may be associated with cycle characteristics so that it is identifiable in the future, as has been previously described.

FIG. 11 is a flowchart of an exemplary set of steps that may be performed with a point of use reservoir device, such as the reservoir device 300, to selectively capture and treat water. As water is received via the waste water input 308, the reservoir device 300 may detect 600 the flow of waste water and prepare one or more components of the system, which may include activating or configuring for use the water sensors 336, the reservoir diverter 330, or other devices. Waste water entering the system may be analyzed by the water sensors 336 to determine characteristics such as temperature, chemical contaminant levels (e.g., from detergents or chemicals washed from clothing), particulate content (e.g., dirt, sediment, fibers), and other characteristics. Other sensor analysis may include, for example, pH, conductivity, dissolved oxygen, chemical oxygen demand, biological oxygen demand, suspended solids, dissolved solids, turbidity, presence of pathogens, pathogenic levels, pathogenic species, fecal coliforms, presence of blood, human biomarkers, ammonia, residual chlorine, bromine, phosphorus, nitrogen, boron, turbidity, color, particle size, flow, and temperature. This may also include determining the volume of incoming waste water and determining, based on a current volume of water stored in the reservoir 320, whether any additional water needs to be captured and stored. Where the water is not usable 604 (e.g., due to undesirable characteristics, or lack of storage space), the reservoir diverter 330 may be actuated to cause the incoming waste water to be diverted 606 to the drain output 318.

Where the water is usable 604, the diverter 330 may be actuated to divert the waste water to be stored 608 in the reservoir 320. While stored in the reservoir 320, the water may be filtered 610 (e.g., either by being circulated through the primary filter 324 by the supply pump 328, or by being filtered on demand as it is transported to the regulator tank), and treated 612 by injections from the cartridge pump 332 or, in the case of non-chemical treatments (e.g., ultraviolet sanitization, electro disinfection, ozone treatment, rapid heating, or plasma treatment), by contact or optical exposure via a treatment module or other device. Treatments 612 may include, for example, introduction of chlorine, bleach, bleach boosters, or other chemicals to inhibit the growth of bacteria or mold, introduction of chemical binders, soil repellent polymers, chelants, or builders to mitigate or aid in the filtration of detergents, fibers, and sediment, and other treatments. Other examples of treatments and filtration may include, for example, gravitational separation, filtration, foam fractionation, hydro-dynamic separation, reverse osmosis, forward osmosis, ultra-filtration, nano-filtration, gravitational separation, sedimentation, centrifugation, coagulation, flocculation, aeration, deaeration, electro-coagulation, electro-disinfection, cold plasma injection, and UV treatment.

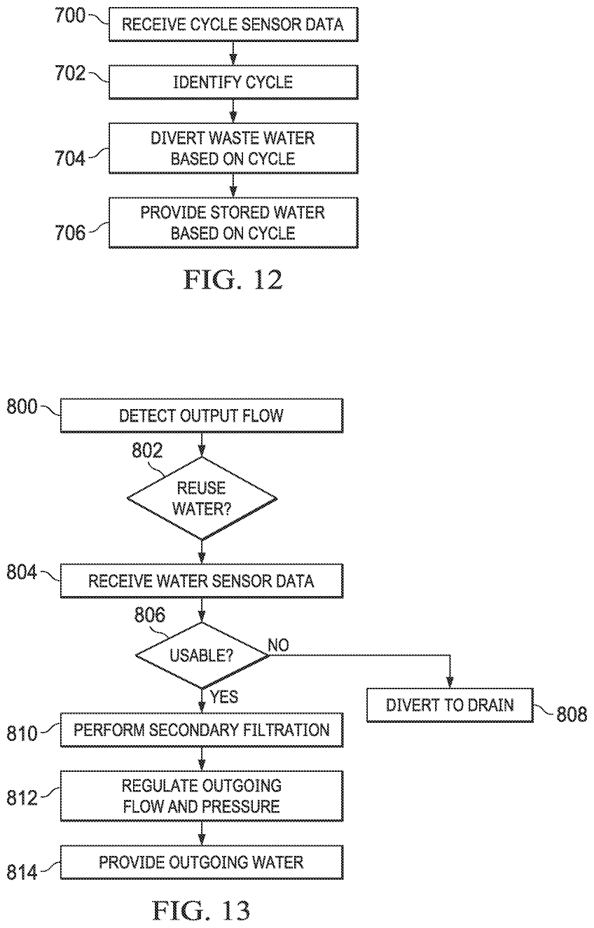

FIG. 12 is a flowchart of an exemplary set of steps that may be performed with a point of use reservoir device to identify a current cycle of a washing machine. As has been described, cycle detection and identification may be performed in varying ways, such as by receiving communications directly from the washing machine 114 via a wired or wireless connection, or by using devices such as the imaging device 364, signal detector 362, microphone 366, or flow sensors, as has been described. As cycle sensor data is received 700, the cycle may be identified 702. Identification 702 may be based upon comparison to historical data that is associated with known cycles, automated identification 702 using an expert process or artificial intelligence process, or other processes. Based upon the identified 702 cycle, the reservoir device 300 may then determine how to divert 704 waste water, and how to provide 706 stored water. As an example, waste water from some washing cycles may be disposed of rather than captured, such as waste water from a first wash, which may contain a high amount of detergent, sediment, and fibers, while waste water from a subsequent rinse cycle may contain little or no chemical content. In such a case, the reservoir device 300 may actuate the reservoir diverter 330 to divert the waste water to the drain output 318 so that it is disposed rather than being transported to the reservoir 320. Thus, waste water may be determined as unusable and disposed of based upon the particular cycle identification 702, water sensor data 602, or both.

Similarly, the reservoir device 300 may provide 706 recycled and treated water to some wash cycles, and may provide 706 fresh water to other wash cycles. As an example, recycled water may be used for an initial wash of clothing and then disposed of, while fresh water may be used for a final rinse cycle.

FIG. 13 is a flowchart of an exemplary set of steps that may be performed with a point of use reservoir device to selectively store and provide recycled water to a washing machine or other point of use. The reservoir device may detect 800 an outgoing flow of water when a coupled washing machine 114 or other point of use begins to consume water. The output flow may be detected 800 based upon a change in pressure, a change in flow of water within an outgoing water channel, or other characteristics. If the current identified 702 cycle is one for which recycled water is provided 706, the reservoir device may operate the supply pump 328 to begin to transport water from the reservoir 320 to the cold water output 312. Prior to being provided 706, the stored water may be analyzed by a water sensor module 326 to ensure usability 806 after it has been stored in the reservoir 320 for a period of time. Where water is unusable 806 after storage in the reservoir 320, such as where a lack of cleaning or treatment due to poor maintenance on filters, sediment drains, or treatment cartridges 338 results in sediment or bacteria being introduced to the water after it is captured, the water may be diverted 808 to the drain outlet 318 and disposed of by operation of the drain pump 322.

Where the water is usable 806 based upon feedback from the water sensor module 326, the system may perform secondary filtration 810 using the secondary filter 340, and provide the recycled water to the regulator tank 342 so that the outgoing flow and pressure of water may be regulated 812, and the water may be provided 814 to the coupled device via the cold water output 312. Regulation 812 of the outgoing flow and pressure may include passive features, such as flow restrictors or other devices to limit and stabilize the flow of outgoing water, and may also include active features such as the use of additional pumps to build water pressure to a level expected by the receiving device. Regulation 812 may also include mixing of recycled water and fresh water, either to build pressure or volume to required levels, or based upon a particular identified cycle (e.g., a first rinse cycle may receive a mix of recycled and fresh water, while a final rinse cycle may receive entirely fresh water).

FIG. 14A through 14C are each schematic diagrams showing water use sequences that may be used with washing machines, and that are illustrative of sequences that may be used with other coupled devices. The sequence of FIG. 14A includes providing recycled water for a primary wash cycle 900, which is then saved and returned to the reservoir device. Recycled water is also used for a first rinse cycle 902, and then is disposed of (e.g., the reservoir diverter 330 is operated when incoming waste water is detected, and the water is diverted to the drain output 318). Fresh water is then provided for a second or final rinse cycle 904, which is saved after used and returned to the reservoir 320, replacing the volume of water that was disposed of after the first rinse cycle 902. The sequence of FIG. 14B includes providing recycled water for a primary wash cycle 906, which is then disposed of. Recycled water is also used for a first rinse cycle 908, and is then saved. Fresh water is then provided for a second or final rinse cycle 910, which is saved after use and returned to the reservoir 320, replacing the volume of water that was disposed of after the primary wash 906. The sequence of FIG. 14C includes providing recycled water for a primary wash cycle 912, which is then disposed of. Fresh water is used for a first rinse cycle 914, and is then saved to replace the volume of water disposed of after the primary wash cycle 912. Recycled water is then provided for a second or final rinse cycle 916, and is saved after use.

Configuration of water use sequences may be preconfigured, or may be dynamically determined based upon sensor data from historic uses of the system. In either case, determination of whether water is used, captured, disposed, or reused may be based at least in part on balancing efficiency against ability to remove detergent or other residue from clothing. For preconfigured sequences, this may include testing with various washing machines and detergents, while for sequences that are at least partially dynamically determined, this may include evaluating sensor data for a particular washing machine and particular detergent over the first several uses of the reservoir device, with the water use sequence being updated after each use.

While the reservoir device 300 and other devices have been described in the context of enabling the capture and use of recycled water for a washing machine, it should be understood that the features disclosed herein may also be readily implemented with a toilet, shower, sink faucet, or other points of use. As an example, this may include water waste from a shower being captured, treated, and reused to provide water for a toilet flush, or water waste from a sink faucet being captured, treated, and reused to provide water for outdoor uses (e.g., automotive cleaning, or watering of plants). Filtration and treatment performed on captured water may vary based upon the point of use it is captured from, and the point of use it is provided to. As an example, water captured from a shower, and intended for subsequent use at a toilet may undergo minimal filtration and may be treated to add a scented perfume or toilet bowl cleaner prior to being provided to the toilet.

### Combinations

### Example 1

A water management method comprising: (a) receiving, by a reservoir device, a volume of waste water from a washing machine, the washing machine having a waste water output and one more water inputs, wherein the reservoir device is in fluid communication with the waste water output and at least one of the one or more water inputs; (b) storing, by the reservoir device, the volume of waste water in a reservoir of the reservoir device; (c) converting, by the reservoir device, the volume of waste water into a volume of recycled water; (d) identifying, by the reservoir device, a cycle type of a cycle being performed by the washing machine; (e) storing, by a processor, a water use sequence that identifies a plurality of cycle types and, for each of the plurality of cycle types, whether that cycle type uses recycled water or fresh water; and (f) based upon the cycle type and the water use sequence: (i) providing, by the reservoir device, at least a portion of the volume of recycled water to the washing machine for the cycle; or (ii) providing, by the reservoir device, a volume of fresh water to the washing machine for the cycle.

### Example 2

The method of example 1, wherein converting the volume of waste water into the volume of recycled water comprises: (a) filtering, by one or more filters of the reservoir device, the volume waste water; and (b) introducing, by a treatment module of the reservoir device, at least one treatment into the volume of waste water.

### Example 3

The method of example 2, wherein the one or more filters of the reservoir device comprise a first filter having a micron rating between about 30 and about 90 microns and a second filter having a micron rating between about 2 and about 10 microns.

### Example 4

The method of any one or more of examples 2 through 3, wherein introducing at least one treatment into the volume of waste water comprises: (a) introducing at least one chemistry selected from the group consisting of surfactants, optical agents, buffers, pH modifiers, perfumes, de-scaling agents, metal sequestration agents, polymers, silicones, deodorization agents, bleaches including halogens and peroxygen compounds, preservation agents, biocidal agents, anti-fungal agents, anti-viral agents and cleaning compositions containing one or more chemistry of the preceding list; (b) subjecting the volume of waste water to one or more of ultraviolet light, electrolysis treatment, ozone treatment, or rapid heating.

### Example 5

The method of any one or more of examples 1 through 5, further comprising: (a) measuring, by a first water sensor module, a set of pre-storage characteristics of the volume of waste water prior to storing the volume of waste water in the reservoir; (b) determining, by the processor, whether the volume of waste water is usable based on the set of pre-storage characteristics; and (c) when the volume of waste water is not usable, operating, by the reservoir device, a diverter valve to cause the volume of waste water to be disposed of via a drain outlet of the reservoir device.

### Example 6

The method of example 5, further comprising: (a) measuring, by a second water sensor module, a set of post-storage characteristics of the volume of recycled water prior to providing the volume of recycled water to the washing machine; (b) determining, by the processor, whether the volume of recycled water is usable based on the set of post-storage characteristics; (c) when the volume of recycled water is not usable: (i) operating, by the reservoir device, a drain pump of the reservoir device to cause the volume of recycled water to be disposed of via a drain outlet of the reservoir device; and (ii) operating, by the reservoir device, a water feed valve to provide fresh water to the washing machine.

### Example 7

The method of any one or more of examples 1 through 6, wherein the one or more water inputs of the washing machine comprise a hot water input and a cold water input, the method further comprising: (a) providing, by the reservoir device, the volume of recycled water or the volume of fresh water via the cold water input; (b) providing, by the reservoir device, hot fresh water to the hot water input by: (i) receiving hot fresh water from a primary infrastructure source; and (ii) transporting the hot fresh water through a bypass channel to the hot water input of the washing machine.

### Example 8

The method of example 7, further comprising: (a) receiving, by the processor, a first set of flow data from a first flow sensor of the reservoir device configured to measure the flow of the volume of fresh water to the washing machine; and (b) receiving, by the processor, a second set of flow data from a second flow sensor of the reservoir device configured to measure the flow of hot fresh water to the washing machine.

### Example 9

The method of example 8, further comprising, causing, by the processor, an interface to display on a user device, wherein the interface comprises: (a) a description of the first set of flow data; (b) a description of the second set of flow data; and (c) a recommendation for using the washing machine and the impact that following the recommendation will have on the first set of flow data and the second set of flow data.

### Example 10

The method of any one or more of examples 1 through 9, further comprising, identifying, by the processor, the cycle type of the cycle being performed by the washing machine by: (a) receiving a set of cycle characteristics from a cycle sensor; and (b) identifying the cycle type based on the set of cycle characteristics.

### Example 11

The method of example 10, wherein the cycle sensor is an imaging device configured to capture images of a control panel of the washing machine during the cycle.

### Example 12

The method of any one or more of examples 10 through 11, wherein the cycle sensor is a microphone configured to capture audible sounds produced by the washing during the cycle.

### Example 13

The method of any one or more of examples 10 through 12, wherein the cycle sensor is an electrical signal detector configured to detect electricity used by the washing machine, or electrical signals emitted by the washing machine, during the cycle.

### Example 14

The method of any one or more of examples 10 through 13, wherein identifying the cycle type based on the set of cycle characteristics comprises: (a) matching, by the processor, the set of cycle characteristics to a previously detected set of cycle characteristics; and (b) identifying, by the processor, the cycle based upon a previously identified cycle that is associated with the previously detected set of cycle characteristics.

### Example 15

The method of any one or more of examples 1 through 14, wherein the water use sequence is configured to cause: (a) providing, by the reservoir device, the volume of recycled water for use during a wash cycle type, and disposing of the volume of waste water produced by the wash cycle type; (b) providing, by the reservoir device, the volume of recycled water for use during a first rinse cycle type, and saving the volume of waste water produced by the first rinse cycle type in the reservoir; and (c) providing, by the reservoir device, the volume of fresh water for use during a subsequent rinse cycle type, and saving the volume of waste water produced by the subsequent rinse cycle type.

### Example 16

The method of any one or more of examples 1 through 15, wherein the water use sequence is configured to cause: (a) providing, by the reservoir device, the volume of recycled water for use during a wash cycle type, and disposing of the volume of waste water produced by the wash cycle type; (b) providing, by the reservoir device, the volume of fresh water for use during a first rinse cycle type, and saving the volume of waste water produced by the first rinse cycle type in the reservoir; and (c) providing, by the reservoir device, the volume of recycled water for use during a subsequent rinse cycle type, and saving the volume of waste water produced by the subsequent rinse cycle type.

### Example 17

The method of any one or more of examples 1 through 16, wherein the water use sequence is configured to cause: (a) providing, by the reservoir device, the volume of recycled water for use during a wash cycle type, and saving the volume of waste water produced by the wash cycle type; (b) providing, by the reservoir device, the volume of recycled water for use during a first rinse cycle type, and disposing of the volume of waste water produced by the first rinse cycle type; and (c) providing, by the reservoir device, the volume of fresh water for use during a subsequent rinse cycle type, and saving the volume of waste water produced by the subsequent rinse cycle type.

### Example 18

A water management method comprising: (a) receiving, by a reservoir device, a volume of waste water from a first point of use, wherein the reservoir device point is in fluid communication with a waste water output of the first point of use and a water input of a second point of use; (b) storing, by the reservoir device, the volume of waste water in a reservoir of the reservoir device; (c) converting, by the reservoir device, the volume of waste water into a volume of recycled water; (d) identifying, by the reservoir device, a water use event of the second point of use; (e) determining, by a processor, whether to provide recycled water or fresh water to the second point of use based on the water use event; and (f) based on the determination: (i) providing, by the reservoir device, at least a portion of the volume of recycled water to the second point of use for the water use event; or (ii) providing, by the reservoir device, a volume of fresh water to the second point of use for the water use event.

### Example 19

The method of example 18, wherein converting the volume of waste water into the volume of recycled water comprises: (a) filtering, by one or more filter modules of the reservoir device, the volume waste water; and (b) introducing, by a treatment module of the reservoir device, at least one treatment into the volume of waste water.

### Example 20

The method of example 19, wherein the one or more filter modules are configured to filter the volume of waste water via one or more of gravitational separation, filtration, foam fractionation, hydro-dynamic separation, reverse osmosis, forward osmosis, ultra-filtration, nano-filtration, gravitational separation, sedimentation, centrifugation, flocculation, aeration, deaeration, electro-coagulation, electro-disinfection, cold plasma injection, and UV treatment.

### Example 21

The method of any one or more of examples 19 through 20, wherein introducing at least one treatment into the volume of waste water includes: (a) introducing at least one chemistry selected from the group consisting of surfactants, optical agents, buffers, pH modifiers, perfumes, de-scaling agents, metal sequestration agents, polymers, silicones, deodorization agents, bleaches including halogens and peroxygen compounds, preservation agents, biocidal agents, anti-fungal agents, anti-viral agents and cleaning compositions containing one or more of the preceding list; or (b) subjecting the volume of waste water to one or more of ultraviolet light, electrolysis treatment, ozone treatment, or rapid heating.

### Example 22

The method of any one or more of examples 18 through 21, further comprising: (a) measuring, by a first water sensor module, a set of pre-storage characteristics of the volume of waste water prior to storing the volume of waste water in the reservoir; (b) determining, by the processor, whether the volume of waste water is usable based on the set of pre-storage characteristics; and (c) when the volume of waste water is not usable, operating, by the reservoir device, a diverter valve to cause the volume of waste water to be disposed of via a drain outlet of the reservoir device.

### Example 23

The method of example 22, further comprising: (a) measuring, by a second water sensor module, a set of post-storage characteristics of the volume of recycled water prior to providing the volume of recycled water to the second point of use; (b) determining, by the processor, whether the volume of recycled water is usable based on the set of post-storage characteristics; (c) when the volume of recycled water is not usable: (i) operating, by the reservoir, a drain pump of the reservoir device to cause the volume of recycled water to be disposed of via a drain outlet of the reservoir device; and (ii) operating, by the reservoir, a water feed valve to provide fresh water to the second point of use.

### Example 24

A reservoir device comprising: (a) a set of connections configured to couple to a waste water output and one or more water inputs of a washing machine; (b) a reservoir configured to receive and store a volume of waste water from the washing machine; (c) one or more treatment devices configured to convert the volume of waste water into a volume of recycled water; (d) a processor configured to: (i) identify a cycle type of a cycle being performed by the washing machine; (ii) store a water use sequence that identifies a plurality of cycle types and, for each of the plurality of cycle types, whether that cycle type uses recycled water or fresh water; and (iii) based upon the cycle type and the water use sequence: (A) provide at least a portion of the volume of recycled water to the washing machine for the cycle; or (B) provide a volume of fresh water to the washing machine for the cycle.

### Example 25

The device of example 24, wherein the one or more treatment devices comprise: (a) one or more filters configured to separate a contaminant from the volume of waste water; (b) a treatment module configured to introduce at least one treatment to the volume of waste water.

### Example 26

The device of example 25, wherein the one or more filters of the reservoir device comprise a first filter having a micron rating between about 30 and about 90 microns and a second filter having a micron rating between about 2 and about 10 microns.

### Example 27

The device of any one or more of examples 25 through 26, wherein the treatment module is further configured to: (a) introduce at least one chemistry selected from the group consisting of surfactants, optical agents, buffers, pH modifiers, perfumes, de-scaling agents, metal sequestration agents, polymers, silicones, deodorization agents, bleaches including halogens and peroxygen compounds, preservation agents, biocidal agents, anti-fungal agents, anti-viral agents and cleaning compositions containing one or more chemistry of the preceding list; (b) subject the volume of waste water to one or more of ultraviolet light, electrolysis treatment, ozone treatment, or rapid heating.

### Example 28

The device of any one or more of examples 24 through 26, further comprising: (a) a first water sensor module configured to measure a set of pre-storage characteristics of the volume of waste water prior to storing the volume of waste water in the reservoir; (b) a diverter valve configured to selectively dispose of the volume of waste water via a drain outlet of the reservoir device prior to storing the volume of waste water in the reservoir; wherein the processor is further configured to: (i) determine whether the volume of waste water is usable based on the set of pre-storage characteristics; and (ii) when the volume of waste water is not usable, operate the diverter valve to cause the volume of waste water to be disposed of.

### Example 29

The device of example 28, further comprising: (a) a second water sensor module configured to measure a set of post-storage characteristics of the volume of recycled water prior to providing the volume of recycled water to the washing machine from the reservoir; (b) a drain pump operable to transport water from the reservoir to a drain outlet of the reservoir device; (c) a water feed valve configured to selectively provide recycled water from the reservoir or fresh water to the washing machine; wherein the processor is further configured to: (i) determine whether the volume of recycled water is usable based on the set of post-storage characteristics; and (ii) when the volume of recycled water is not usable: (A) operate the drain pump to cause the volume of recycled water to be disposed of via the drain outlet; and (B) operate the water feed valve to provide fresh water to the washing machine.

### Example 30

The device of any one or more of examples 24 through 29, further comprising a water feed valve configured to selectively provide recycled water from the reservoir or fresh water to the washing machine, wherein: (a) the one or more water inputs of the washing machine comprise a hot water input and a cold water input; (b) the processor is further configured to operate the water feed valve to provide the volume of recycled water or the volume of fresh water via the cold water input; and (c) hot fresh water is received from a primary infrastructure source and provided to the hot water input through a bypass channel of the reservoir device.

### Example 31

The device of example 30, further comprising: (a) a first flow sensor configured to measure the flow of the volume of fresh water to the washing machine; and (b) a second flow sensor configured to measure the flow of hot fresh water to the washing machine; wherein the processor is further configured to: (i) receive a first set of flow data from the first flow sensor; (b) receive, by the processor, a second set of flow data from a second flow sensor of the reservoir device configured to measure the flow of hot fresh water to the washing machine.

### Example 32

The device of example 31, wherein the processor is further configured to cause an interface to display on a user device, wherein the interface comprises: (a) a description of the first set of flow data; (b) a description of the second set of flow data; and (c) a recommendation for using the washing machine and the impact that following the recommendation will have on the first set of flow data and the second set of flow data.

### Example 33

The device of any one or more of examples 24 through 32, further comprising a cycle sensor, wherein the processor is further configured to: (a) receiving a set of cycle characteristics from the cycle sensor; and (b) identify the cycle type of the cycle being performed by the washing machine based on the set of cycle characteristics.

### Example 34

The device of example 33, wherein the cycle sensor comprises an imaging device configured to capture images of a control panel of the washing machine during the cycle.

### Example 35

The device of any one or more of examples 33 through 34, wherein the cycle sensor comprises a microphone configured to capture audible sounds produced by the washing during the cycle.

### Example 36

The device of any one or more of examples 33 through 35, wherein the cycle sensor comprises an electrical signal detector configured to detect electricity used by the washing machine, or electrical signals emitted by the washing machine, during the cycle.

### Example 37

The device of any one or more of examples 33 through 36, wherein the processor is further configured to, when identifying the cycle type based on the set of cycle characteristics: (a) match the set of cycle characteristics to a previously detected set of cycle characteristics; and (b) identify the cycle based upon a previously identified cycle that is associated with the previously detected set of cycle characteristics.

### Example 38

The device of any one or more of examples 24 through 37 wherein the processor is further configured to, based on the water use sequence: (a) cause the volume of recycled water to be provided for use during a wash cycle type, and cause the volume of waste water produced by the wash cycle type to be disposed of; (b) cause the volume of recycled water to be provided for use during a first rinse cycle type, and cause the volume of waste water produced by the first rinse cycle type to be saved in the reservoir; and (c) cause the volume of fresh water to be provided for use during a subsequent rinse cycle type, and cause the volume of waste water produced by the subsequent rinse cycle type to be saved in the reservoir.

### Example 39

The device of any one or more of examples 24 through 38 wherein the processor is further configured to, based on the water use sequence: (a) cause the volume of recycled water to be provided for use during a wash cycle type, and cause the volume of waste water produced by the wash cycle type to be disposed of; (b) cause the volume of fresh water to be provided for use during a first rinse cycle type, and cause the volume of waste water produced by the first rinse cycle type to be saved in the reservoir; and (c) cause the volume of recycled water to be provided for use during a subsequent rinse cycle type, and cause the volume of waste water produced by the subsequent rinse cycle type to be saved in the reservoir.

### Example 40

The device of any one or more of examples 24 through 39, wherein the processor is further configured to, based on the water use sequence: (a) cause the volume of recycled water to be provided for use during a wash cycle type, and cause the volume of waste water produced by the wash cycle type to be saved in the reservoir; (b) cause the volume of recycled water to be provided for use during a first rinse cycle type, and cause the volume of waste water produced by the first rinse cycle type to be disposed of; and (c) cause the volume of fresh water to be provided for use during a subsequent rinse cycle type, and cause the volume of waste water produced by the subsequent rinse cycle type to be saved in the reservoir.

### Example 41

A reservoir device comprising: (a) a set of connections configured to couple to a waste water output of a first point of use and a water input of a second point of use; (b) a reservoir configured to receive and store a volume of waste water from the first point of use; (c) one or more treatment devices configured to convert the volume of waste water into a volume of recycled water; (d) a processor configured to: (i) identify a water use event of the second point of use; (ii) determine whether to provide recycled water or fresh water to the second point of use based on the water use event; and (iii) based on the determination: (i) provide at least a portion of the volume of recycled water to the second point of use for the water use event; or (ii) provide a volume of fresh water to the second point of use for the water use event.

### Example 42

The device of example 41, wherein the one or more treatment devices comprise: (a) one or more filter modules configured to separate a contaminant from the volume of recycled water; and (b) a treatment module configured to introduce at least one treatment into the volume of waste water.

### Example 43

The device of example 42, wherein the one or more filter modules are configured to filter the volume of waste water via one or more of gravitational separation, filtration, foam fractionation, hydro-dynamic separation, reverse osmosis, forward osmosis, ultra-filtration, nano-filtration, gravitational separation, sedimentation, centrifugation, flocculation, aeration, deaeration, electro-coagulation, electro-disinfection, cold plasma injection, and UV treatment.

### Example 44

The device of any one or more of examples 42 through 43, wherein the treatment module is further configured to: (a) introduce at least one chemistry selected from the group consisting of surfactants, optical agents, buffers, pH modifiers, perfumes, de-scaling agents, metal sequestration agents, polymers, silicones, deodorization agents, bleaches including halogens and peroxygen compounds, preservation agents, biocidal agents, anti-fungal agents, anti-viral agents and cleaning compositions containing one or more chemistry of the preceding list; (b) subject the volume of waste water to one or more of ultraviolet light, electrolysis treatment, ozone treatment, or rapid heating.

### Example 45

The device of any one or more of examples 41 through 44, further comprising: (a) a first water sensor module configured to measure a set of pre-storage characteristics of the volume of waste water prior to storing the volume of waste water in the reservoir; (b) a diverter valve configured to selectively dispose of the volume of waste water via a drain outlet of the reservoir device prior to storing the volume of waste water in the reservoir; wherein the processor is further configured to: (i) determine whether the volume of waste water is usable based on the set of pre-storage characteristics; and (ii) when the volume of waste water is not usable, operate the diverter valve to cause the volume of waste water to be disposed of.

### Example 46

The device of example 45, further comprising: (a) a second water sensor module configured to measure a set of post-storage characteristics of the volume of recycled water prior to providing the volume of recycled water to the second point of use from the reservoir; (b) a drain pump operable to transport water from the reservoir to a drain outlet of the reservoir device; (c) a water feed valve configured to selectively provide recycled water from the reservoir or fresh water to the second point of use; wherein the processor is further configured to: (i) determine whether the volume of recycled water is usable based on the set of post-storage characteristics; and (ii) when the volume of recycled water is not usable: (A) operate the drain pump to cause the volume of recycled water to be disposed of via the drain outlet; and (B) operate the water feed valve to provide fresh water to the second point of use.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A reservoir device comprising:
(a) a set of connections configured to couple to a waste water output and one or more water inputs of a washing machine;
(b) a reservoir configured to receive and store a volume of waste water from the washing machine;
(c) one or more treatment devices configured to convert the volume of waste water into a volume of recycled water;
(d) a processor configured to:
(i) identify a cycle type of a cycle being performed by the washing machine;
(ii) store a water use sequence that identifies a plurality of cycle types and, for each of the plurality of cycle types, whether that cycle type uses recycled water or fresh water; and
(iii) based upon the cycle type and the water use sequence:
(A) provide at least a portion of the volume of recycled water to the washing machine for the cycle; or
(B) provide a volume of fresh water to the washing machine for the cycle.

2. The device of claim 1, wherein the one or more treatment devices comprise:
(a) one or more filters configured to separate a contaminant from the volume of waste water;
(b) a treatment module configured to introduce at least one treatment to the volume of waste water.

3. The device of claim 2, wherein the one or more filters of the reservoir device comprise a first filter having a micron rating between about 30 and about 90 microns and a second filter having a micron rating between about 2 and about 10 microns.

4. The device of claim 2, wherein the treatment module is further configured to:
(a) introduce at least one chemistry selected from the group consisting of surfactants, optical agents, buffers, pH modifiers, perfumes, de-scaling agents, metal sequestration agents, polymers, silicones, deodorization agents, bleaches including halogens and peroxygen compounds, preservation agents, biocidal agents, anti-fungal agents, anti-viral agents and cleaning compositions containing one or more chemistry of the preceding list;
(b) subject the volume of waste water to one or more of ultraviolet light, electrolysis treatment, ozone treatment, or rapid heating.

5. The device of claim 1, further comprising:
(a) a first water sensor module configured to measure a set of pre-storage characteristics of the volume of waste water prior to storing the volume of waste water in the reservoir;
(b) a diverter valve configured to selectively dispose of the volume of waste water via a drain outlet of the reservoir device prior to storing the volume of waste water in the reservoir;
wherein the processor is further configured to:
(i) determine whether the volume of waste water is usable based on the set of pre-storage characteristics; and
(ii) when the volume of waste water is not usable, operate the diverter valve to cause the volume of waste water to be disposed of.

6. The device of claim 5, further comprising:
(a) a second water sensor module configured to measure a set of post-storage characteristics of the volume of recycled water prior to providing the volume of recycled water to the washing machine from the reservoir;
(b) a drain pump operable to transport water from the reservoir to a drain outlet of the reservoir device;
(c) a water feed valve configured to selectively provide recycled water from the reservoir or fresh water to the washing machine;
wherein the processor is further configured to:
(i) determine whether the volume of recycled water is usable based on the set of post-storage characteristics; and
(ii) when the volume of recycled water is not usable:
(A) operate the drain pump to cause the volume of recycled water to be disposed of via the drain outlet; and
(B) operate the water feed valve to provide fresh water to the washing machine.

7. The device of claim 6, wherein the processor is further configured to cause an interface to display on a user device, wherein the interface comprises:
(a) a description of the first set of flow data;
(b) a description of the second set of flow data; and
(c) a recommendation for using the washing machine and the impact that following the recommendation will have on the first set of flow data and the second set of flow data.

8. The device of claim 1, further comprising a cycle sensor, wherein the processor is further configured to:
(a) receiving a set of cycle characteristics from the cycle sensor; and
(b) identify the cycle type of the cycle being performed by the washing machine based on the set of cycle characteristics.

9. The device of claim 8, wherein the cycle sensor comprises an imaging device configured to capture images of a control panel of the washing machine during the cycle.

10. The device of claim 8, wherein the cycle sensor comprises a microphone configured to capture audible sounds produced by the washing during the cycle.

11. The device of claim 8, wherein the cycle sensor comprises an electrical signal detector configured to detect electricity used by the washing machine, or electrical signals emitted by the washing machine, during the cycle.

12. The device of claim 8, wherein the processor is further configured to, when identifying the cycle type based on the set of cycle characteristics:
(a) match the set of cycle characteristics to a previously detected set of cycle characteristics; and
(b) identify the cycle based upon a previously identified cycle that is associated with the previously detected set of cycle characteristics.

13. The device of claim 1, wherein the processor is further configured to, based on the water use sequence:
(a) cause the volume of recycled water to be provided for use during a wash cycle type, and cause the volume of waste water produced by the wash cycle type to be disposed of;
(b) cause the volume of recycled water to be provided for use during a first rinse cycle type, and cause the volume of waste water produced by the first rinse cycle type to be saved in the reservoir; and
(c) cause the volume of fresh water to be provided for use during a subsequent rinse cycle type, and cause the volume of waste water produced by the subsequent rinse cycle type to be saved in the reservoir.

14. The device of claim 1, wherein the processor is further configured to, based on the water use sequence:
(a) cause the volume of recycled water to be provided for use during a wash cycle type, and cause the volume of waste water produced by the wash cycle type to be disposed of;
(b) cause the volume of fresh water to be provided for use during a first rinse cycle type, and cause the volume of waste water produced by the first rinse cycle type to be saved in the reservoir; and
(c) cause the volume of recycled water to be provided for use during a subsequent rinse cycle type, and cause the volume of waste water produced by the subsequent rinse cycle type to be saved in the reservoir.

15. The device of claim 1, wherein the processor is further configured to, based on the water use sequence:
(a) cause the volume of recycled water to be provided for use during a wash cycle type, and cause the volume of waste water produced by the wash cycle type to be saved in the reservoir;
(b) cause the volume of recycled water to be provided for use during a first rinse cycle type, and cause the volume of waste water produced by the first rinse cycle type to be disposed of; and
(c) cause the volume of fresh water to be provided for use during a subsequent rinse cycle type, and cause the volume of waste water produced by the subsequent rinse cycle type to be saved in the reservoir.
